(19) United States
(12) Patent Application Publication
(10) Pub. No.: US 2013/0135352 A1
(43) Pub. Date: May 30, 2013

(54) INFORMATION PROCESSING APPARATUS AND DISPLAY CONTROL METHOD

(71) Applicants: Kyohei Matsuda, Ome-shi (JP); Yukihiro Suda, Tachikawa-shi (JP)

(72) Inventors: Kyohei Matsuda, Ome-shi (JP); Yukihiro Suda, Tachikawa-shi (JP)

(21) Appl. No.: 13/593,085

(22) Filed: Aug. 23, 2012

(30) Foreign Application Priority Data
Nov. 25, 2011 (JP) 2011-257299

(51) Int. Cl. G09G 5/32

(52) U.S. Cl. 345/659

(57) ABSTRACT

According to one embodiment, an information processing apparatus includes a base unit having an upper surface on which a keyboard is placed, a display unit which is set at one of a first position at which a display surface of the display unit and the keyboard are exposed and a second position at which a rear surface of the display unit covers an upper surface of the base unit, a screen image rotation module, and a control module. The screen image rotation module rotates a screen image on a display surface of the display unit in accordance with an orientation of the display unit relative to a gravity direction. The control module inhibits rotation of the screen image if the display unit is set at the first position.

### CROSS-REFERENCE TO RELATED APPLICATIONS

This application is based upon and claims the benefit of priority from Japanese Patent Application No. 2011-257299, filed Nov. 25, 2011, the entire contents of which are incorporated herein by reference.

### FIELD

Embodiments described herein relate generally to an information processing apparatus such as a convertible tablet computer and a display control method applied to the apparatus.

### BACKGROUND

Recently, various types of tablet computers have been developed. Many tablet computers have a screen rotation function. This screen rotation function changes the orientation of a screen image on the display in accordance with the orientation of the tablet computer. In this case, this function automatically changes the orientation of the screen image so as to match it with the gravity direction.

The screen rotation function of the tablet computer is useful in improving the operability of the tablet computer.

If, however, the screen rotation function is always kept active, a screen image may rotate depending on the tilt of the tablet computer or the like against the user's wish not to rotate the screen image.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating outer appearances respectively corresponding to the notebook mode and tablet mode of an information processing apparatus according to an embodiment;

FIG. 2 is a perspective view illustrating an outer appearance when the information processing apparatus according to this embodiment is viewed from the front surface in the notebook mode;

FIG. 3 is a perspective view illustrating an outer appearance when the information processing apparatus according to this embodiment is viewed from the right side surface in the notebook mode;

FIG. 4 is a perspective view illustrating an outer appearance when the information processing apparatus according to this embodiment is viewed from the right side surface in a transition process from the notebook mode to the tablet mode;

FIG. 5 is a perspective view illustrating an outer appearance when the information processing apparatus according to this embodiment is viewed from the right side surface in the tablet mode;

FIG. 6 is a block diagram illustrating the system configuration of the information processing apparatus according to this embodiment;

FIG. 7 is a perspective view for explaining the three axial directions of an acceleration sensor provided for the information processing apparatus according to this embodiment;

FIG. 8 is a view for explaining the orientations of a screen image which respectively correspond to the four orientations of the display of the information processing apparatus according to this embodiment in the tablet mode;

FIG. 9 is a view illustrating how the orientation of a screen image on the display of the information processing apparatus according to this embodiment is fixed regardless of the orientation of the display in the notebook mode;

FIG. 10 is a block diagram illustrating the functional arrangement of a screen rotation control program executed by the information processing apparatus according to this embodiment;

FIG. 11 is a flowchart for explaining a procedure for screen rotation control processing executed by the information processing apparatus according to this embodiment;

FIG. 12 is a view for explaining a software rotation lock button displayed on the display of the information processing apparatus according to this embodiment;

FIG. 13 is a flowchart for explaining another procedure for screen rotation control processing executed by the information processing apparatus according to this embodiment;

FIG. 14 is a view for explaining processing for controlling an angular range in which screen rotation is permitted, which is executed by the information processing apparatus according to this embodiment;

FIG. 15 is a view for explaining the processing of changing the display mode from the landscape mode to the portrait mode, which is executed by the information processing apparatus according to this embodiment; and

FIG. 16 is a view for explaining the processing of changing the display mode from the portrait mode to the landscape mode, which is executed by the information processing apparatus according to this embodiment.

### DETAILED DESCRIPTION

Various embodiments will be described hereinafter with reference to the accompanying drawings.

In general, according to one embodiment, an information processing apparatus includes a base unit having an upper surface on which a keyboard is placed, a display unit which is set at one of a first position at which a display surface of the display unit and the keyboard are exposed and a second position at which a rear surface of the display unit covers an upper surface of the base unit, a screen image rotation module, and a control module. The screen image rotation module rotates a screen image on a display surface of the display unit in accordance with an orientation of the display unit relative to a gravity direction. The control module permits rotation of the screen image if the display unit is set at the second position, and inhibits rotation of the screen image and fixes the orientation of the screen image to a predetermined orientation if the display unit is set at the first position.

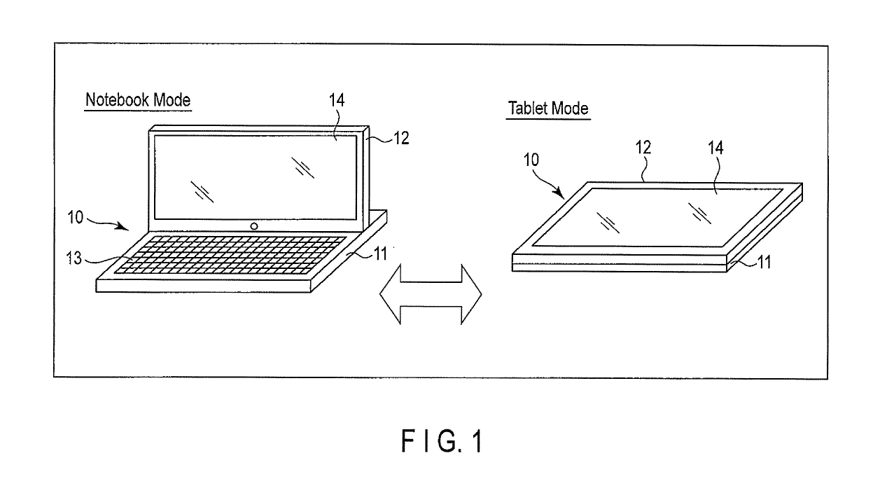

FIG. 1 illustrates outer appearances respectively corresponding to the notebook mode and tablet mode of an information processing apparatus according to an embodiment. This information processing apparatus is implemented as, for example, a convertible tablet computer 10. The convertible tablet computer 10 is used in either of the forms, namely the notebook mode shown on the left side of FIG. 1 and the tablet mode shown on the right side of FIG. 1.

The computer 10 includes a base unit 11 and a display unit 12. The base unit 11 includes a thin rectangular housing accommodating a CPU, a memory, other various types of electronic components, and the like. A keyboard 13 is placed on the upper surface of the base unit 11.

A flat panel display 14 is placed on the front surface of the display unit 12, i.e., the display surface of the display unit 12. The flat panel display 14 is implemented as, for example, a touchscreen display which can detect the position of a pen or finger on the display 14.

The display unit 12 is set at either a first position corresponding to a style in the notebook mode shown on the left portion of FIG. 1 or a second position corresponding to a style in the tablet mode shown on the right portion of FIG. 1. More specifically, the display unit 12 is set either at the first position described above at which the display surface of the display unit 12 and the keyboard 13 are exposed or the second position described above at which the rear surface of the display unit 12 covers the upper surface of the base unit 11.

In the notebook mode, the computer 10 is mainly used in a state in which it is placed on a horizontal surface such as the surface of a desk. In the notebook mode, the user mainly operates the keyboard 13. In addition, in the notebook mode, a landscape mode (horizontal display mode) is mainly used as a display mode.

In contrast, in the tablet mode, the computer 10 is mainly used in a state in which it is handheld by the user with his/her one hand or both hands. The user mainly touches the display 14 with a pen or finger. In addition, in the tablet mode, the display mode is switched between the landscape mode (horizontal display mode) and the portrait mode (vertical display mode). More specifically, in the tablet mode, the display mode is switched between four types of modes, namely the landscape mode (horizontal display mode), the inverted landscape mode (inverted horizontal display mode), the portrait mode (vertical display mode), and the inverted portrait mode (inverted vertical display mode). The inverted landscape mode and the inverted portrait mode are also called the landscape (flipped) mode and the portrait (flipped) mode, respectively.

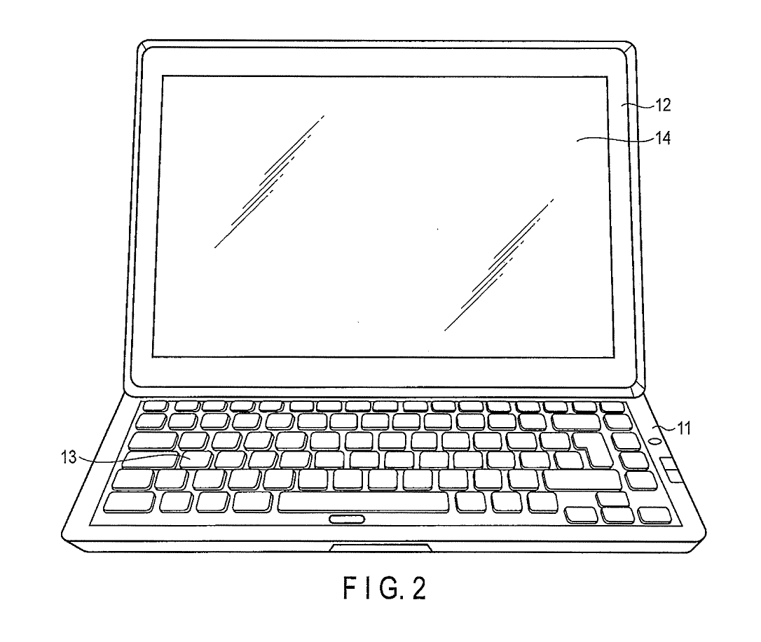

An example of the structure of the computer 10 will be described next with reference to FIGS. 2, 3, 4, and 5.

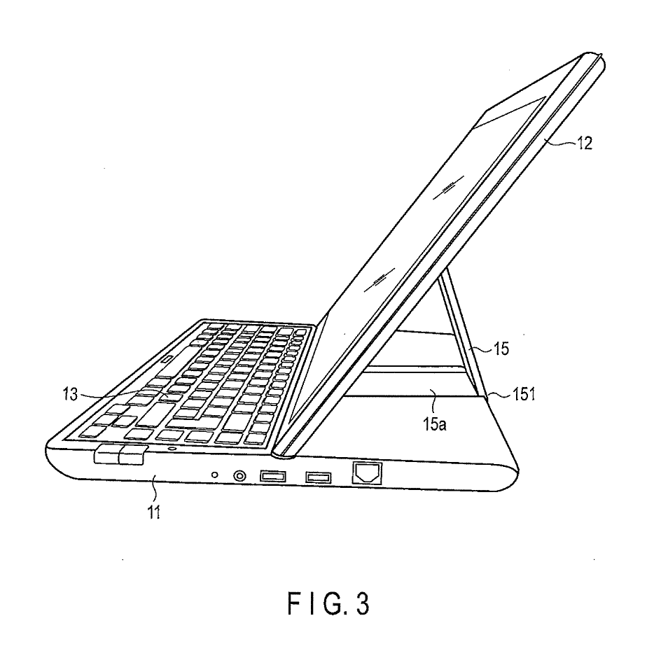

FIG. 2 is a perspective view showing an outer appearance when the computer 10 is viewed from the front surface in the notebook mode. FIG. 3 is a perspective view showing an outer appearance when the computer 10 is viewed from the right side surface in the notebook mode. In the notebook mode, the display unit 12 is raised upright on the base unit 11 so as to expose the keyboard 13 on the base unit 11. In this case, as shown in FIG. 3, a support member 15 supports the display unit 12. The support member 15 functions as a so-called “display arm”.

A groove 15a for accommodating the support member 15 is provided on the rear side on the upper surface of the base unit 11. The support member 15 is attached to the rear end portion of the base unit 11 through a coupling portion 151 so as to pivot between a closed position at which the support member 15 is accommodated in the groove 15a and an open position at which the support member 15 protrudes upward from the base unit 11. That is, the support member 15 pivots around an axis parallel to the upper surface of the base unit 11. The rear surface of the display unit 12 is attached to the distal end portion of the support member 15 through the coupling portion.

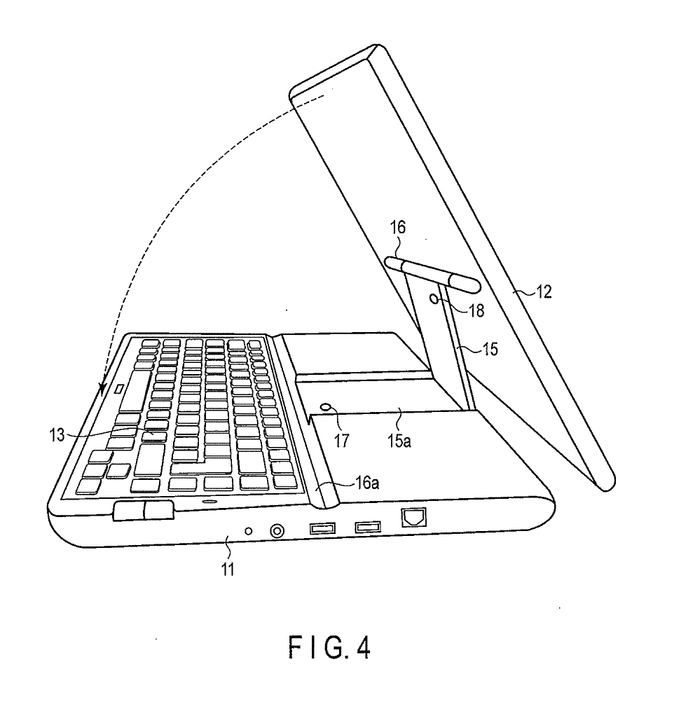

FIG. 4 is a perspective view showing an outer appearance when the configuration of the computer 10 is viewed from the right side surface in a transition process from the notebook mode to the tablet mode. The distal end portion of the support member 15 is attached to the rear surface of the display unit 12 through a coupling portion 16 so as to make the display unit 12 pivot around an axis perpendicular to the longitudinal direction of the support member 15.

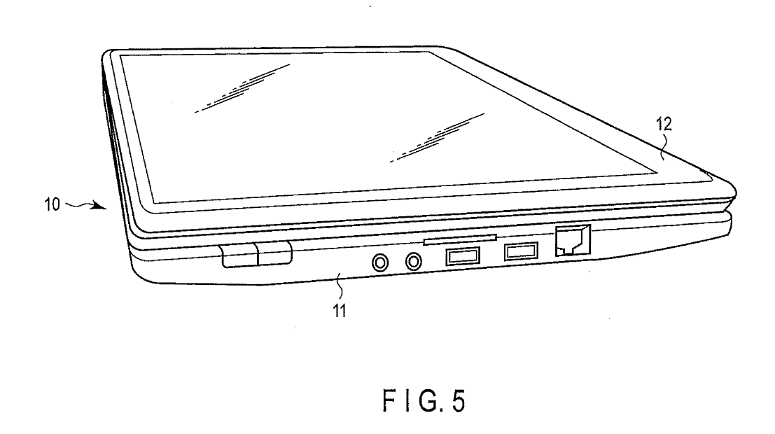

At the time of transition from the notebook mode to the tablet mode, as shown in FIG. 4, the display unit 12 pivots through about 180° about the coupling portion 16 so as to make the display surface face backward. In this case, the user removes the lower side of the display unit 12 from a groove 16a in the upper surface of the base unit 11, and makes the display unit 12 pivot to the rear so as to make the display surface of the display unit 12 face backward. This sets the display unit 12 in a state in which the lower and upper sides of the display unit 12 are located at the upper and lower levels, respectively. When the user tilts the support member 15 forward in this state, the support member 15 and the coupling portion 16 are respectively accommodated in the grooves 15a and 16a. As a result, as shown in FIG. 5, the computer 10 is set in the tablet mode in which the rear surface of the display unit 12 covers the upper surface of the base unit 11.

A mode detection switch 17 configured to determine whether the computer 10 is set in the tablet mode or the notebook mode is placed on the upper surface of the base unit 11, e.g., on the groove 15a. In the tablet mode, a projection 18 on the bottom surface of the support member 15 comes into contact with the mode detection switch 17 to turn on the mode detection switch 17. The ON state of the mode detection switch 17 indicates that the computer 10 is in the tablet mode. The off-state of the mode detection switch 17 indicates that the computer 10 is in the notebook mode.

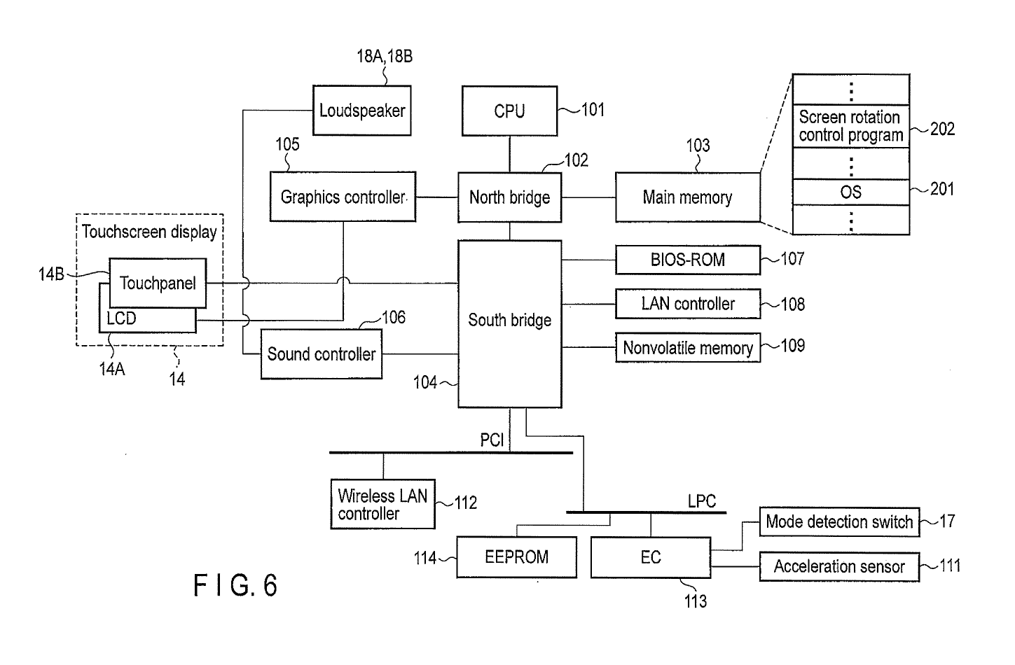

The system configuration of the computer 10 will be described next with reference to FIG. 6.

The computer 10 includes a CPU 101, a north bridge 102, a main memory 103, a south bridge 104, a graphics controller 105, a sound controller 106, a BIOS-ROM 107, a LAN controller 108, a nonvolatile memory 109, the mode detection switch 17, an acceleration sensor 111, a wireless LAN controller 112, an embedded controller (EC) 113, and an EEPROM 114.

The CPU 101 is a processor which controls the operation of various components in the computer 10. The CPU 101 executes an operating system (OS) 201 and various kinds of application programs loaded from the nonvolatile memory 109 into the main memory 103. The application programs include a screen rotation control program 202.

The screen rotation control program 202 determines whether the computer 10 is currently set in the tablet mode or the notebook mode, and executes the screen rotation processing of rotating a screen image on the display 14 in accordance with the orientation of the display unit 12 relative to the gravity direction if the computer 10 is set in the tablet mode. In this case, the screen rotation control program 202 detects the tilt of the computer 10 (the tilt of the display unit 12 in the tablet mode) relative to the gravity direction by using the acceleration sensor 111, and changes the orientation of a screen image in accordance with the tilt of the display unit 12 relative to the gravity direction. In other words, the orientation of the screen image is automatically changed such that the upper end side of the screen image is located above the lower end side of the screen image relative to the gravity direction.

In contrast, when the computer 10 is currently set in the notebook mode, the screen rotation control program 202 fixes the orientation of a screen image to the orientation determined in advance for the notebook mode by inhibiting the execution of screen rotation processing. Even when the computer 10 is set in the notebook mode, the user may carry the computer 10 while it is active. In this case, the screen image may rotate in the orientation unexpected by the user in accordance with the tilt of the computer 10. The notebook mode is a mode premised on the use of the keyboard 13. In the notebook mode, therefore, the necessity to rotate a screen image is very low. In this embodiment, when the computer 10 is currently set in the notebook mode, the execution of screen rotation processing is inhibited to prevent a phenomenon in which a screen image rotates in accordance with the tilt of the tablet computer or the like against the user's wish not to rotate the screen image.

The CPU 101 executes a basic input and output system (BIOS) stored in the BIOS-ROM 107. The BIOS is a program for hardware control.

The north bridge 102 is a bridge device configured to connect the local bus of the CPU 101 to the south bridge 104. The north bridge 102 also incorporates a memory controller which performs access control on the main memory 103. The north bridge 102 has a function of executing communication with the graphics controller 105 via a PCI EXPRESS serial bus.

The graphics controller 105 is a display controller configured to control an LCD 14A used as the display monitor of the computer 10. The display signal generated by the graphics controller 105 is sent to the LCD 14A. The LCD 14A displays the video based on the display signal. A touchpanel 14B is placed on the LCD 14A. The touchpanel 14B is a pointing device for performing input operation on the screen of the LCD 14A. The user can operate a graphical user interface (GUI) or the like displayed on the screen of the LCD 14A by using the touchpanel 14B. For example, the user can issue an instruction to execute a function corresponding to a button displayed on the screen by touching the button.

The south bridge 104 controls each device on a PCI (Peripheral Component Interconnect) bus and each device on an LPC (Low Pin Count) bus. The south bridge 104 also incorporates an ATA controller for controlling the nonvolatile memory 109.

The south bridge 104 has a function of executing communication with the sound controller 106. The sound controller 106 is a sound source device, which outputs audio data to be reproduced to loudspeakers 18A and 18B. The LAN controller 108 is a wired communication device which executes wired communication based on, for example, IEEE802.3 standard. The wireless LAN controller 112 is a wireless communication device which executes wireless communication based on, for example, IEEE802.11 standard.

The EC 113 is a one-chip microcomputer including an embedded controller for power management. The EC 113 has a function of powering the computer 10 on or off in accordance with the operation of a power button by the user. The acceleration sensor 111 is connected to the EC 113. The acceleration sensor 111 is a sensor configured to detect the orientation of the computer 10, i.e., the tilt of the computer 10 (display unit 12) relative to gravity. The acceleration sensor 111 is configured to detect, for example, accelerations in directions respectively corresponding to the three axes, i.e., the X-, Y-, and Z-axes.

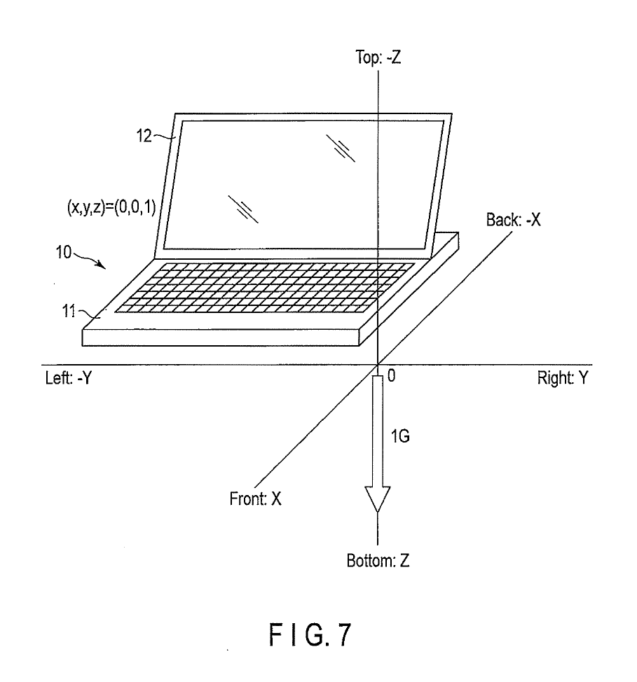

FIG. 7 shows an example of each of the directions corresponding to the three axes of the acceleration sensor 111. The X-axis is an axis parallel to a side surface of the base unit 11 of the computer 10 (an axis parallel to a side surface of the display unit 12 in the tablet mode), with the front and rear sides respectively corresponding to +X and −X. The Y-axis is an axis parallel to the front surface of the base unit 11 (an axis parallel to the lower end portion of the display unit 12 in the tablet mode), with the left and right sides respectively corresponding to −Y and +Y. The Z-axis is an axis perpendicular to the upper surface of the base unit 11 (an axis perpendicular to the display surface of the display unit 12 in the tablet mode), with the upper end side and the bottom end side respectively corresponding to −Z and +Z.

While the computer 10 is placed on a horizontal surface as shown in FIG. 7, an output (x, y, z) from the acceleration sensor 111 becomes (0, 0, 1).

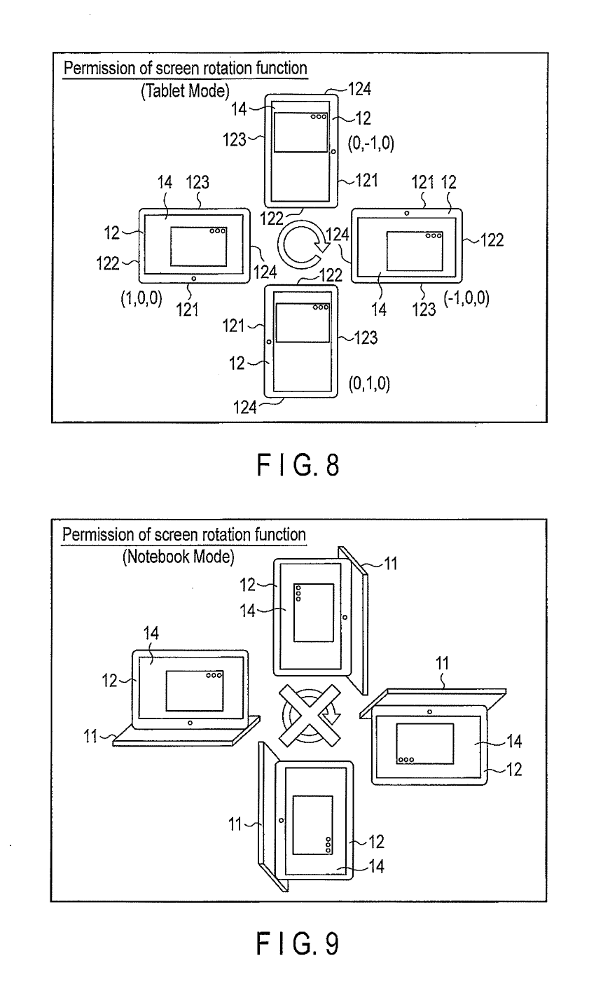

The screen rotation function permitted in the tablet mode will be described next with reference to FIG. 8.

In the tablet mode, the orientations of the computer 10 are roughly classified into four angles, namely a landscape angle (horizontal position), inverted landscape angle (inverted horizontal position), portrait angle (vertical position), and inverted portrait angle (inverted vertical position).

The left portion in FIG. 8 indicates the landscape angle. When the computer 10 is at the landscape angle, the display mode is changed to the landscape mode. In the landscape mode, the orientation of a screen image is controlled such that the upper end side of the screen image is located on an upper side 123 of the display unit 12, and the lower end side of the screen image is located on a lower side 121 of the display unit 12.

The upper portion in FIG. 8 indicates the inverted portrait angle. When the computer 10 is at the inverted portrait angle, the display mode is changed to the inverted portrait mode. In the inverted portrait mode, the orientation of a screen image is controlled such that the upper end side of the screen image is located on a right side 124 of the display unit 12, and the lower end side of the screen image is located on a left side 122 of the display unit 12.

The right portion in FIG. 8 indicates the inverted landscape angle. When the computer 10 is at the inverted landscape angle, the display mode is changed to the inverted landscape mode. In the inverted landscape mode, the orientation of a screen image is controlled such that the upper end side of the screen image is located on the lower side 121 of the display unit 12, and the lower end side of the screen image is located on the upper side 123 of the display unit 12.

The lower portion in FIG. 8 indicates the portrait angle. When the computer 10 is at the portrait angle, the display mode is changed to the portrait mode. In the portrait mode, the orientation of a screen image is controlled such that the upper end side of the screen image is located on the left side 122 of the display unit 12, and the lower end side of the screen image is located on the right side 124 of the display unit 12.

In contrast, in the notebook mode, the screen rotation function is inhibited. Therefore, a screen image is displayed in the same orientation as shown in FIG. 9 regardless of whether the computer 10 is at the landscape angle (horizontal position), inverted landscape angle (inverted horizontal position), portrait angle (vertical position), or inverted portrait angle (inverted vertical position).

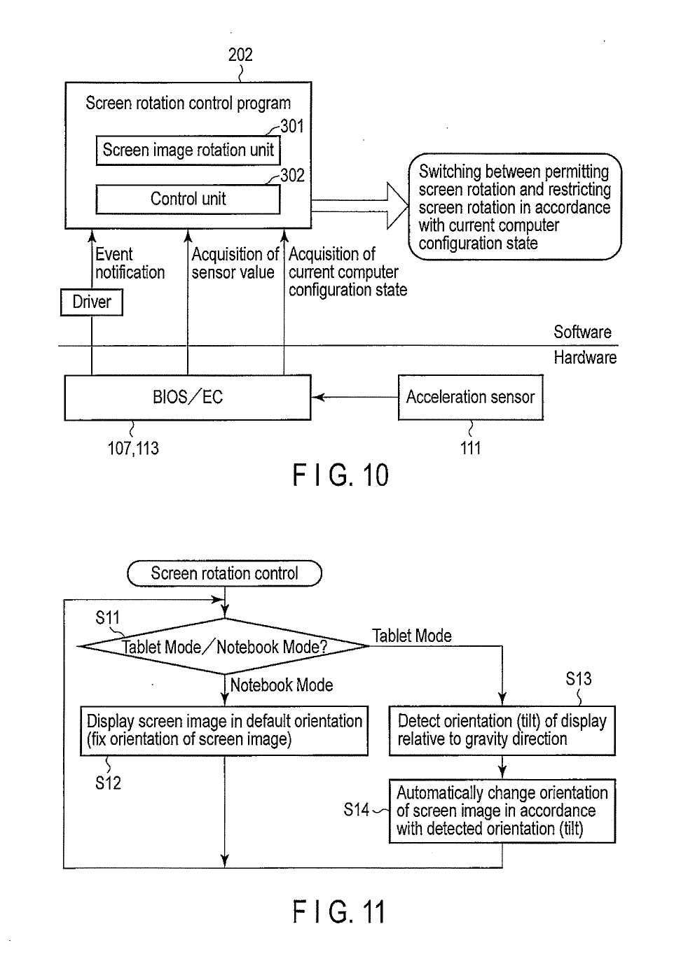

The arrangement of the screen rotation control program 202 will be described next with reference to FIG. 10.

As described above, the EC 113 is connected to the acceleration sensor 111. When the acceleration sensor 111 detects a change in the tilt of the computer 10 relative to gravity, i.e., the acceleration value (x, y, z) of the acceleration sensor 111 changes by a predetermined amount, the screen rotation control program 202 is notified of an event indicating the change in the tilt of the computer 10 via the BIOS and driver program. In response to the reception of the notification of this event, the screen rotation control program 202 acquires a sensor value indicating the orientation of the display unit 12 relative to the gravity direction, i.e., the acceleration value (x, y, z) detected by the acceleration sensor 111, from the EC 113. In addition, the screen rotation control program 202 acquires a value indicating the on/off state of the mode detection switch 17 (the current computer configuration state) from the EC 113.

The screen rotation control program 202 includes a screen image rotation module 301 and a control module 302. The screen image rotation module 301 rotates a screen image on the display surface of the display unit 12 in accordance with the orientation of the display unit 12 relative to the gravity direction. Although the screen rotation control program 202 alone may execute the processing of rotating the screen image, the screen rotation control program 202 and the operating system 201 may execute the processing in cooperation with each other. In this case, the screen rotation control program 202 determines which one of the portrait mode, inverted portrait mode, landscape mode, and inverted landscape mode described above is set as a display mode. The screen rotation control program 202 then sets an argument designating the determined display mode to the API of the operating system 201. The operating system 201 displays the screen image in the display mode designated by this argument.

When the computer 10 is set in the tablet mode, i.e., the display unit 12 is set at the second position described above, the control module 302 permits the rotation of the screen image. In contrast to this, when the computer 10 is set in the notebook mode, i.e., the display unit 12 is set at the first position described above, the control module 302 inhibits the rotation of the screen image and fixes the orientation of the screen image to a predetermined orientation. The predetermined orientation of the screen image is an orientation in which the upper end side of the screen image is located on the upper side 123 of the display unit 12, and the lower end side of the screen image is located on the lower side 121 of the display unit 12.

A procedure for screen rotation control processing executed by the screen rotation control program 202 will be described next with reference to the flowchart of FIG. 11.

First of all, the screen rotation control program 202 determines whether the computer 10 is set in the tablet mode or the notebook mode (step S11). If the computer 10 is set in the notebook mode, the screen rotation control program 202 inhibits the execution of the screen rotation function and displays the screen image on the display 14 in a default orientation corresponding to the notebook mode (step S12). The default orientation is the same as the predetermined orientation described above. The screen image displayed on the display 14 is fixed to the predetermined orientation described above.

If the computer 10 is in the tablet mode, the screen rotation control program 202 detects the orientation (tilt) of the display unit 12 relative to the gravity direction (step S13). The screen rotation control program 202 changes the orientation of the screen image displayed on the display 14 in accordance with the detected orientation (tilt) of the display unit 12 (step S14). In step S14, the screen rotation control program 202 determines, in accordance with the detected orientation (tilt) of the display unit 12, which one of the portrait mode, inverted portrait mode, landscape mode, and inverted landscape mode described above is set as a display mode. The screen rotation control program 202 displays the screen image in an orientation corresponding to the determined display mode.

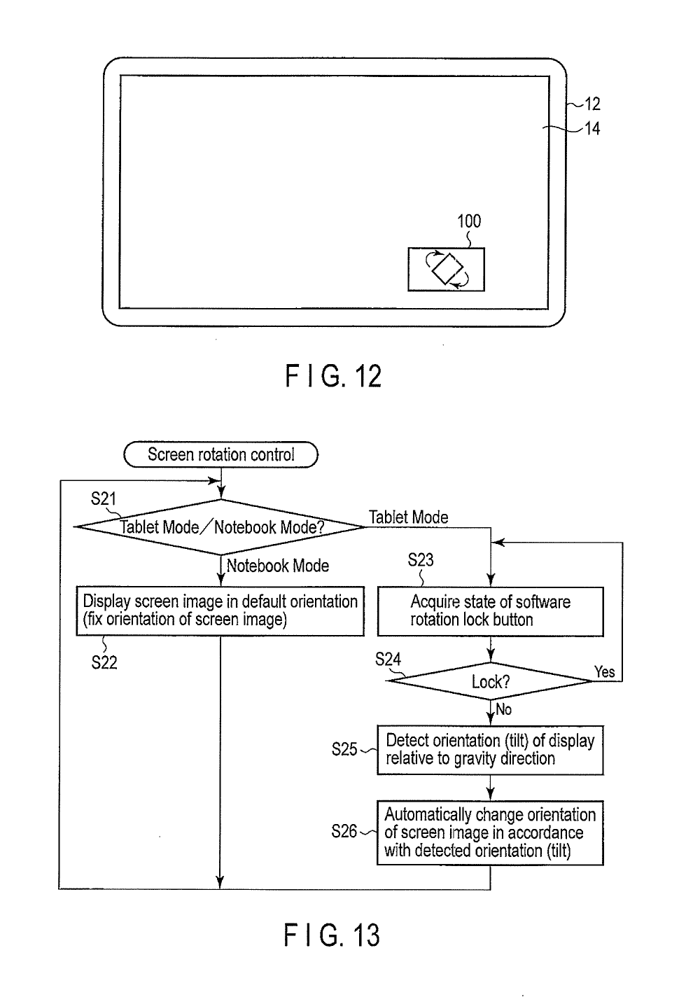

Note that the control module 302 may display a software rotation lock button 100 like that shown in FIG. 12 on the display 14. The software rotation lock button 100 is a button for issuing an instruction to inhibit the rotation of a screen image. In this embodiment, since the rotation of a screen image is inhibited when the computer 10 is in the notebook mode, the software rotation lock button 100 may be displayed only when the computer 10 is set in the tablet mode. If the user operates the software rotation lock button 100 while the computer 10 is in the tablet mode, the control module 302 inhibits the rotation of the screen image (screen rotation lock). In this case, the control module 302 does not execute the processing of changing the orientation of a screen image in accordance with a change in the tilt of the computer 10, and fixes the orientation of the screen image to the current orientation of the screen image (one of the portrait mode, inverted portrait mode, landscape mode, and inverted landscape mode).

When the user operates the software rotation lock button 100 again, the control module 302 releases the screen rotation lock. This resumes the processing of changing the orientation of a screen image in accordance with a change in the tilt of the computer 10.

It is possible to change the display icon of the software rotation lock button 100 in accordance with a lock state and an unlock state (a key mark appears on the software rotation lock button 100 in the lock state, and disappears in the unlock state). Since screen rotation is restricted from the beginning in the notebook mode, there is no need to display the software rotation lock button 100.

The software rotation lock button 100 is displayed on the display 14 when the notebook mode shifts to the tablet mode. The software rotation lock button 100 disappears from the display 14 when the tablet mode shifts to the notebook mode.

A procedure for screen rotation control processing in a case in which the software rotation lock button 100 is used will be described next with reference to the flowchart of FIG. 13.

First of all, the screen rotation control program 202 determines whether the computer 10 is set in the tablet mode or the notebook mode (step S21). If the computer 10 is set in the notebook mode, the screen rotation control program 202 inhibits the execution of the screen rotation function, and displays a screen image on the display 14 in a default orientation corresponding to the notebook mode (step S22). The display 14 does not display the software rotation lock button 100.

If the computer 10 is set in the tablet mode, the display 14 displays the software rotation lock button 100. First of all, the screen rotation control program 202 acquires the state of the software rotation lock button 100 (step S23), and determines whether the screen rotation lock state is set (step S24). If the screen rotation lock state is set (YES in step S24), the screen rotation control program 202 inhibits the execution of the screen rotation function. This fixes a screen image to the current orientation of the screen image (one of the portrait mode, inverted portrait mode, landscape mode, and inverted landscape mode).

If the screen rotation lock state is not set (NO in step S24), the screen rotation control program 202 detects the orientation (tilt) of the display unit 12 relative to the gravity direction (step S25). The screen rotation control program 202 changes the orientation of the screen image displayed on the display 14 in accordance with the detected orientation (tilt) of the display unit 12 (step S26).

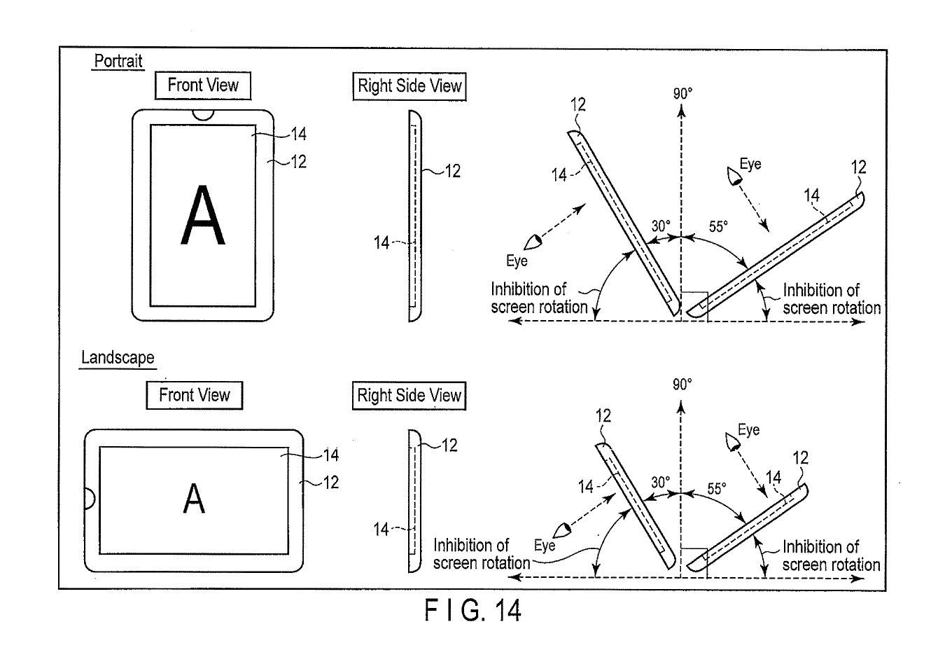

The processing of controlling the angular range of the display unit 12 in which the screen rotation function is permitted will be described next with reference to FIG. 14.

When the computer 10 is set in the tablet mode, the user may use the computer 10 in various positions, e.g., sitting on a chair, standing upright, or lying on a couch. While the user is in a lying state, he/she may handhold the computer 10 with his/her one hand or both hands and look up the display 14. While the user is in this position, the orientation of the computer 10 is not stable. For this reason, a screen image may rotate depending on the tilt or the like of the tablet computer against the user's wish not to rotate the screen image.

In this embodiment, when the computer 10 is set in the tablet mode, the control module 302 controls the angular range in which the execution of the screen rotation function is permitted, in the following manner.

When the computer 10 is set in the tablet mode, the control module 302 permits the execution of the screen rotation function if, for example, the tilt angle of the display unit 12 falls within the angular range between 30° forward and 55° backward, as shown in FIG. 14.

That is, when the angle defined by the rear surface of the display unit 12 and the horizontal axis is set within the range of 0 to 90°, i.e., within the range from an angle at which the display surface of the display unit 12 faces immediately above to, an angle at which the display surface faces in a horizontal direction, the control module 302 permits the execution of the screen rotation function under the condition that the angle defined by the rear surface of the display unit 12 and the vertical axis is equal to or less than a first angle (55°). If the angle defined by the rear surface of the display unit 12 and the vertical axis is larger than the first angle (55°), the control module 302 inhibits the execution of the screen rotation function.

Note that in the tablet mode, the rear surface of the display unit 12 is parallel to the rear surface of the base unit 11, and hence the above angle defined by the rear surface of the display unit 12 and the horizontal axis is synonymous with the angle defined by the rear surface of the base unit 11 and the horizontal axis.

If the angle defined by the rear surface of the display unit 12 and the horizontal axis is set within the range of 90 to 180°, i.e., within the range from an angle at which the display surface of the display unit 12 faces in the horizontal direction to an angle at which the display surface faces immediately below, the control module 302 permits the rotation of the screen image under the condition that the angle defined by the rear surface of the display unit 12 and the vertical axis is equal to or less than a second angle (30°) smaller than the first angle. If the angle defined by the rear surface of the display unit 12 and the vertical axis is larger than the second angle (30°), the control module 302 inhibits the execution of the screen rotation function.

As described above, in this embodiment, the range of the angles defined by the rear surface of the display unit 12 and the vertical axis, in which the screen rotation function is permitted, varies depending on whether the display surface of the display unit 12 is tilted forward or backward. In this case, when the display surface of the display unit 12 is tilted forward, the range of the angles defined by the rear surface of the display unit 12 and the vertical axis, in which the screen rotation function is permitted, is smaller than that when the display surface of the display unit 12 is tilted backward. With this control, even when the user operates the computer 10 while lying on a couch or the like, the control module 302 inhibits screen rotation if the computer 10 is not held with the rear surface of the display unit 12 being almost parallel to the vertical axis, i.e., the angle defined by the rear surface of the display unit 12 and the vertical axis is not equal to or less than, for example, 30°. This can prevent a screen image from rotating because of the instability of the orientation of the computer 10.

Note that the control of the angular range in which the execution of the screen rotation function is permitted described with reference to FIG. 14 can be applied to not only a convertible tablet computer but also a normal tablet computer.

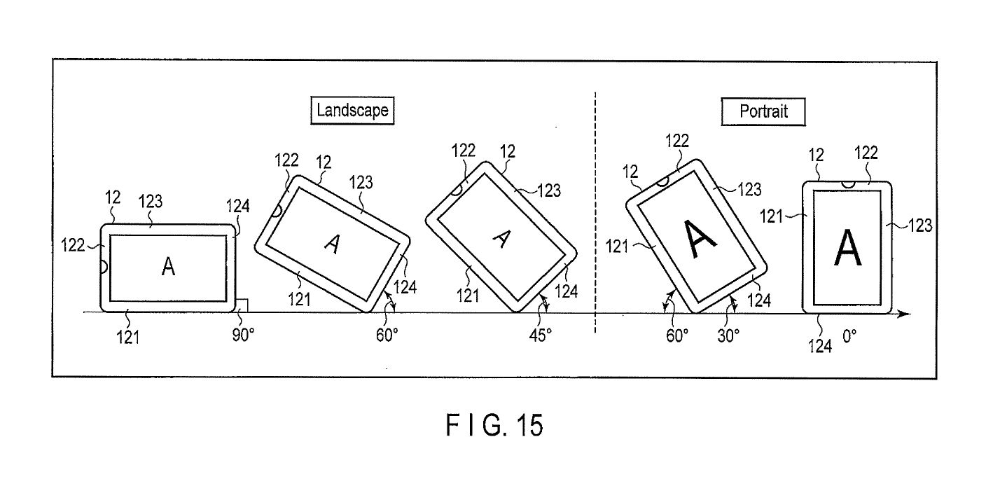

The processing of changing the display mode from the landscape mode to the portrait mode will be described next with reference to FIG. 15. FIG. 15 shows an assumption that the time advances from left to right, and the display unit 12 is switched from the landscape angle to the portrait angle. Assume that the tilt angle of the display unit 12, i.e., the angle defined by the rear surface of the display unit 12 and the horizontal axis, falls within the angular range in which the screen rotation function is permitted.

Assume that the display unit 12 is set at the landscape angle. The angle defined by the right side 124 of the display unit 12 and the horizontal axis is 90°. The display unit 12 is rotated clockwise. As the display unit 12 rotates clockwise, the angle defined by the right side 124 of the display unit 12 and the horizontal axis gradually decreases. When the angle defined by the right side 124 of the display unit 12 and the horizontal axis becomes a threshold angle (e.g., 30°) smaller than 45°, i.e., the angle defined by the lower side 121 of the display unit 12 and the horizontal axis becomes, for example, 60°, the screen image rotation module 301 detects that the display unit 12 has changed from the landscape angle to the portrait angle. The screen image rotation module 301 then switches the display mode from the landscape mode to the portrait mode.

Note that it is possible to change the value of the above threshold depending on whether the display surface of the display unit 12 is tilted forward or backward. In this case, if the display surface of the display unit 12 is tilted forward, it is possible to use a threshold angle (e.g., 20°) smaller than that when the display surface of the display unit 12 is tilted backward, in order to restrict the rotation of the screen.

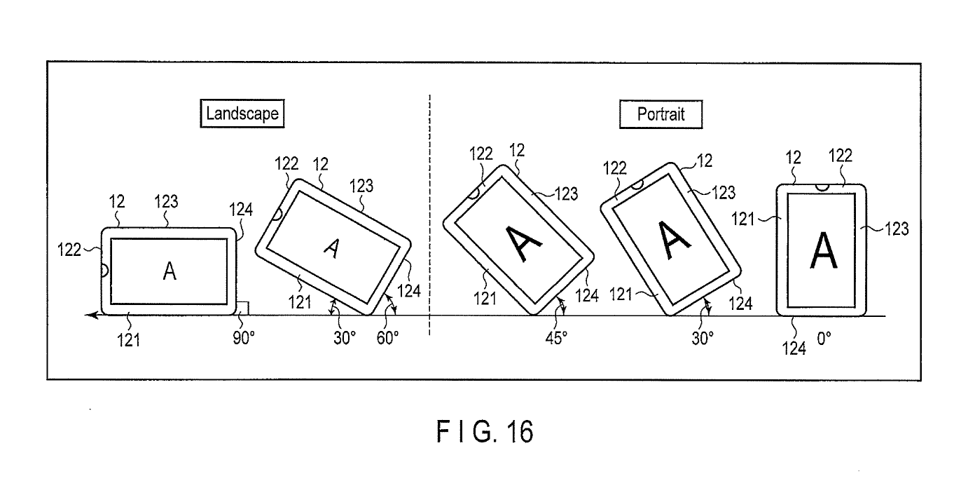

The processing of changing the display mode from the portrait mode to the landscape mode will be described next with reference to FIG. 16. FIG. 16 shows an assumption that the time advances from right to left, and the display unit 12 is switched from the portrait angle to the landscape angle. Assume that the tilt angle of the display unit 12 falls within the angular range in which the screen rotation function is permitted.

Assume that the display unit 12 is set at the portrait angle. The angle defined by the right side 124 of the display unit 12 and the horizontal axis is 0°. The user rotates the display unit 12 counterclockwise. As the display unit 12 rotates counterclockwise, the angle defined by the right side 124 of the display unit 12 and the horizontal axis gradually increases. When the angle defined by the right side 124 of the display unit 12 and the horizontal axis becomes a threshold angle (e.g., 60°) larger than 45°, i.e., the angle defined by the lower side 121 of the display unit 12 and the horizontal axis becomes, for example, 30°, the screen image rotation module 301 detects that the display unit 12 has changed from the portrait angle to the landscape angle. The screen image rotation module 301 then switches the display mode from the portrait mode to the landscape mode.

Note that it is possible to change the value of the above threshold (60°) depending on whether the display surface of the display unit 12 is tilted forward or backward. In this case, if the display surface of the display unit 12 is tilted forward, it is possible to use a threshold angle (e.g., 70°) larger than that when the display surface of the display unit 12 is tilted backward, in order to restrict the rotation of the screen.

As described above, according to this embodiment, if the display unit 12 is set at the second position, i.e., the computer 10 is set in the tablet mode, the rotation of a screen image is permitted. If the display unit 12 is set at the first position, i.e., the computer 10 is set in the notebook mode, the rotation of a screen image is inhibited and the orientation of the screen image is fixed to a predetermined orientation.

The operation mode of the computer 10 is automatically switched between the mode of permitting the screen rotation function and the mode of inhibiting the screen rotation function in accordance with switching between the notebook mode in which the user mainly performs operation such as keyboard input operation and the screen mode is mainly set in the landscape (horizontal) display mode and the tablet mode in which the user mainly performs operation by touching or with a stylus while holding the computer 10 in one hand, and the computer 10 is mainly used such that the screen is rotated in accordance with the tilt of the computer 10. This can prevent an operation error such as rotating the screen in accordance with the tilt of the computer 10 when the user accidentally tilts the computer 10 as he/she carries the computer 10 in an active state in the notebook mode. In addition, since the screen rotation function is automatically permitted at the time of switching from the notebook mode to the tablet mode, the user need not perform dedicated operation for permitting the screen rotation function.

Note that since it is possible to execute the overall processing procedure according to this embodiment by software, it is possible to easily implement the same effect as that of this embodiment by only installing a computer program which executes the processing procedure in a computer such as a convertible tablet computer via a computer-readable storage medium storing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a base unit having an upper surface on which a keyboard is placed;
a display unit which is set at one of a first position at which a display surface of the display unit and the keyboard are exposed and a second position at which a rear surface of the display unit covers an upper surface of the base unit;
a screen image rotation module configured to rotate a screen image on a display surface of the display unit in accordance with an orientation of the display unit relative to a gravity direction; and
a control module configured to permit rotation of the screen image if the display unit is set at the second position and inhibit rotation of the screen image and fix an orientation of the screen image to a predetermined orientation if the display unit is set at the first position.

2. The apparatus of claim 1, wherein the control module is configured to permit rotation of the screen image, if the display unit is set at the second position and an angle defined by a rear surface of the display unit and a horizontal axis is set within a range of 0 to 90° so as to direct the display surface upward, on a condition that an angle defined by the rear surface of the display unit and a vertical axis is not more than a first angle, and configured to permit rotation of the screen image, if the display unit is set at the second position and an angle defined by the rear surface of the display unit and the horizontal axis is set within a range of 90 to 180° so as to direct the display surface downward, on a condition that an angle defined by the rear surface of the display unit and the vertical axis is not more than a second angle smaller than the first angle.

3. The apparatus of claim 1, wherein the control module is configured to display, on the display surface of the display unit, a button for issuing an instruction to inhibit rotation of the screen image if the display unit is set at the second position, and configured to inhibit rotation of the screen image in response to operation of the button.

4. The apparatus of claim 3, wherein the control module is configured to permit rotation of the screen image in response to re-operation of the button.

5. An information processing apparatus comprising:
a base unit having an upper surface on which a display is placed;
a screen image rotation module configured to rotate a screen image on the display in accordance with an orientation of the display relative to a gravity direction; and
a control module configured to permit rotation of the screen image, if an angle defined by a rear surface of the base unit and a horizontal axis is set within a range of 0 to 90° so as to direct a display surface of the display upward, on a condition that an angle defined by the rear surface of the base unit and a vertical axis is not more than a first angle, and configured to permit rotation of the screen image, if an angle defined by the rear surface of the base unit and a horizontal axis is set within a range of 90 to 180° so as to direct the display surface of the display downward, on a condition that an angle defined by the rear surface of the base unit and the vertical axis is not more than a second angle smaller than the first angle.

6. A display control method applied to an information processing apparatus comprising a base unit having an upper surface on which a keyboard is placed, and a display unit which is set at one of a first position at which a display surface of the display unit and the keyboard are exposed and a second position at which a rear surface of the display unit covers an upper surface of the base unit, the method comprising:
determining whether the display unit is set at the first position or the second position;
rotating a screen image on the display surface of the display unit in accordance with an orientation of the display unit relative to a gravity direction if the display unit is set at the second position; and
inhibiting rotation of the screen image and fixing an orientation of the screen image to a predetermined orientation if the display unit is set at the first position.

7. A computer-readable, non-transitory storage medium having stored thereon a computer program which is executed by a computer, the computer comprising a base unit having an upper surface on which a keyboard is placed, and a display unit which is set at one of a first position at which a display surface of the display unit and the keyboard are exposed and a second position at which a rear surface of the display unit covers an upper surface of the base unit, the computer program controlling the computer to execute functions of:
determining whether the display unit is set at the first position or the second position;
rotating a screen image on the display surface of the display unit in accordance with an orientation of the display unit relative to a gravity direction if the display unit is set at the second position; and
inhibiting rotation of the screen image and fixing an orientation of the screen image to a predetermined orientation if the display unit is set at the first position.
